(19) United States
(12) Patent Application Publication
(10) Pub. No.: US 2024/0235024 A1
(43) Pub. Date: Jul. 11, 2024

(54) EXTERNAL TRIPLE-FREQUENCY ANTENNA FOR UNMANNED AERIAL VEHICLE

(71) Applicant: AUTEL ROBOTICS CO., LTD., Shenzhen (CN)

(72) Inventors: Jianping SONG, Shenzhen (CN); Xuefeng SUN, Shenzhen (CN); Jianlei WANG, Shenzhen (CN)

(73) Assignee: AUTEL ROBOTICS CO., LTD., Shenzhen (CN)

(21) Appl. No.: 18/542,595

(22) Filed: Dec. 16, 2023

Related U.S. Application Data
(63) Continuation of application No. PCT/CN2022/099232, filed on Jun. 16, 2022.

(30) Foreign Application Priority Data
Jun. 16, 2021 (CN) 202110665219.3

(51) Int. Cl. H01Q 5/335; H01Q 1/28

(52) U.S. Cl. CPC H01Q 5/335; H01Q 1/28

(57) ABSTRACT

The present disclosure falls within the technical field of communications, and specifically discloses an external triple-frequency antenna for an unmanned aerial vehicle, including a substrate, vibrator circuits, and a feed line. Preferably, the vibrator circuits are disposed on the substrate. The vibrator circuits include a high-frequency vibrator circuit, a middle-frequency vibrator circuit, and a low-frequency vibrator circuit; a shared microstrip line is disposed between the middle-frequency vibrator circuit and the low-frequency vibrator circuit; the feed line includes a first feed line and a second feed line, where the first feed line is connected to the high-frequency vibrator circuit; and the second feed line is connected to the shared microstrip line, and a capacitor is disposed at the connection of the second feed line and the shared microstrip line.

### CROSS-REFERENCE TO THE RELATED APPLICATION

The present application is a continuation of International Application No. PCT/CN2022/099232, filed on Jun. 16, 2022; which claims priority to the Chinese patent application No. 2021106652193 entitled “external triple-frequency antenna for unmanned aerial vehicle” filed on Jun. 16, 2021, the entire disclosures of both of which are incorporated herein by reference for all purposes.

### TECHNICAL FIELD

The present invention relates to the technical field of communications, particularly to an external triple-frequency antenna for an unmanned aerial vehicle.

### BACKGROUND

In unmanned aerial vehicle communication applications, the communication load usually requires a mobile communication terminal antenna to have multi-band, high gain, large bandwidth, and other performance characteristics to meet the communication requirements. With the development of mobile terminals to be miniaturized, higher requirements have been put forward for the antenna size.

### SUMMARY

The present disclosure provides an external triple-frequency antenna for an unmanned aerial vehicle.

According to a first aspect, the disclosure provides an external triple-frequency antenna for an unmanned aerial vehicle, including a substrate; and an vibrator circuit laid on the substrate, where the vibrator circuit includes a high-frequency vibrator circuit, a middle-frequency vibrator circuit, and a low-frequency vibrator circuit; and where a shared microstrip line is disposed between the middle-frequency vibrator circuit and the low-frequency vibrator circuit; and

a feed line, including a first feed line and a second feed line, where the first feed line is connected to the high-frequency vibrator circuit; and the second feed line is connected to the shared microstrip line, and where a capacitor is disposed at a connection of the second feed line and the shared microstrip line.

It is to be understood that both the foregoing general description and the following detailed description are exemplary and explanatory only and are not restrictive of the present disclosure.

### BRIEF DESCRIPTION OF THE DRAWINGS

The accompanying drawings illustrated here are provided for further understanding of the present disclosure and constitute a part of the present disclosure. The illustrative examples of the present disclosure and their descriptions are used to explain the present disclosure and do not constitute an undue limitation of the present disclosure. In the accompanying drawings:

FIG. 1 is a front plan view of an external triple-frequency antenna for an unmanned aerial vehicle provided in this embodiment.

FIG. 2 is a back plan view of an external triple-frequency antenna for an unmanned aerial vehicle provided in this embodiment.

FIG. 3 is a front plan view of FIG. 1 with a second feed line removed.

FIG. 4 is a back plan view of FIG. 2 with a first feed line removed.

FIG. 5 is a locally enlarged view at point A in FIG. 1.

FIG. 6 is an antenna pattern view of a low frequency band of an antenna.

FIG. 7 is an antenna pattern view of a middle frequency band of an antenna.

FIG. 8 is an antenna pattern view of a high frequency band of an antenna.

### DETAILED DESCRIPTION

The present disclosure will be described in further details below with reference to the accompanying drawings and embodiments. It should be understood that the specific embodiments described herein are illustrative of the present disclosure only instead of being restrictive. It should also be noted that, for ease of description, only some parts, but not all, of the structures associated with the present disclosure are shown in the drawings.

In the description of the present disclosure, unless otherwise clearly specified and limited, the terms “connected,” “connect,” and “fix” should be understood in a broad sense. For example, it can be a fixed connection or a detachable connection, or an integrated connection; it can be a mechanical connection, or an electrical connection; it can be directly connected or indirectly connected through an middle middle, and it can be the internal communication of two elements or the interaction relationship between two elements. For a person of ordinary skills in the art, the specific meaning of the above-mentioned terms in the present disclosure can be understood according to specific situations.

In the present disclosure, unless otherwise clearly specified and limited, the first feature being “above” or “below” the second feature may include the direct contact between the first feature and second feature, or may include the situation that the first feature and the second feature are not in direct contact but are connected through another feature therebetween. Further, the first feature being “above,” “on,” and “beyond” the second feature includes that the first feature is directly above and obliquely above the second feature, or merely indicates that the first feature is at a higher level than the second feature. The first feature being “below;” “under,” and “beneath” the second feature includes that the first feature is directly below and obliquely below the second feature, or simply indicates that the first feature is at a lower level than the second feature.

In the description of the present embodiment, the orientation or positional relationships indicated by the terms “up.” “down,” “right”, etc. are based on the orientation or positional relationship shown in the drawings, and are only for the convenience of descriptions and simplifying the operations, rather than indicating or implying that the referred device or element must have a specific orientation, or be constructed and operated in a specific orientation, and therefore cannot be construed as a limitation of the present disclosure. Further, the terms “first” and “second” are used merely to distinguish one from another in a descriptive sense and not in a specific sense. In situations without further limitations, the use of the phrase “a . . . ,” such as “a feed line” to define an element does not exclude the existence of additional identical elements within items or devices that include the aforementioned element.

Following numerals may be used in this disclosure:
1, a substrate; 11, a notch; 12, an avoidance slot; 21, a first high-frequency vibrator circuit; 211, a U-shaped microstrip line; 212, an extended microstrip line; 22, a second high-frequency vibrator circuit; 3, a middle-frequency vibrator circuit; 31, a fourth microstrip line; 32, a fifth microstrip line; 4, a low-frequency vibrator circuit; 41, a sixth microstrip line; 42, a seventh microstrip line; 5, a first feed line; 6, a second feed line; 71, a first microstrip line; 72, a second microstrip line; 73, a third microstrip line; 81, an eighth microstrip line; 82, a ninth microstrip line; 83, a tenth microstrip line; 84, an eleventh microstrip line; 85, a twelfth microstrip line; and 9, a capacitor.

In external triple-frequency antennas for an unmanned aerial vehicle, since the frequencies of the low frequency band and the middle frequency band in three frequency bands (978 MHz, 1.09 GHz, and 5.8 GHz) are close, it makes the layout of vibrator circuits more complicated, and it is difficult to make the antenna structure design more compact.

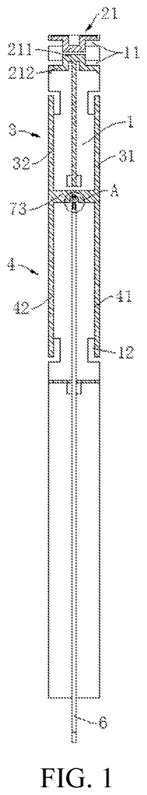

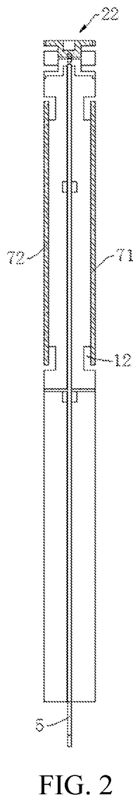

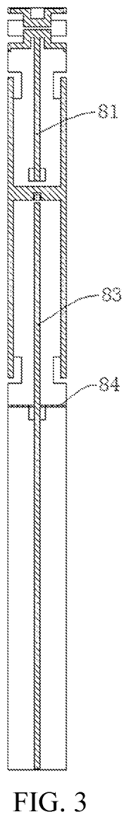

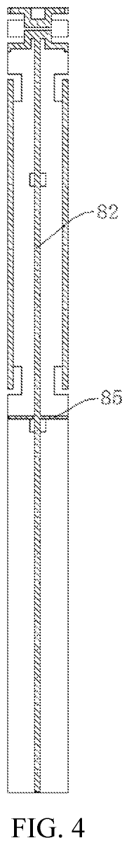

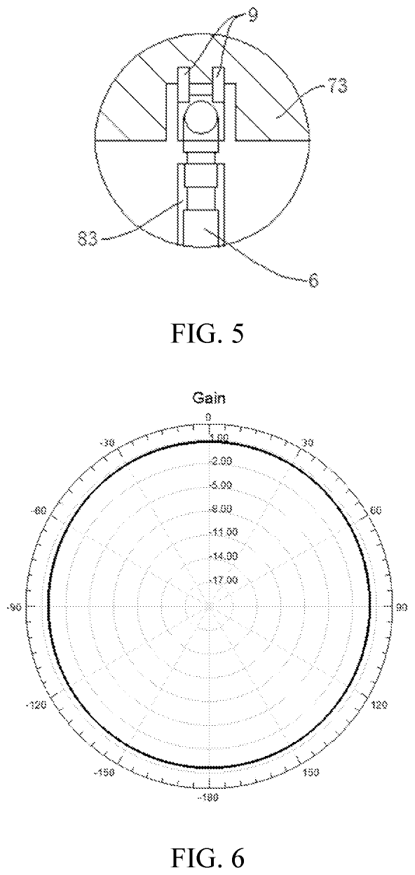

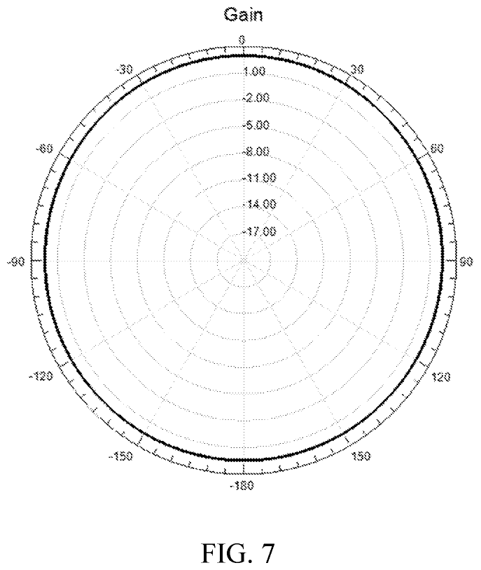

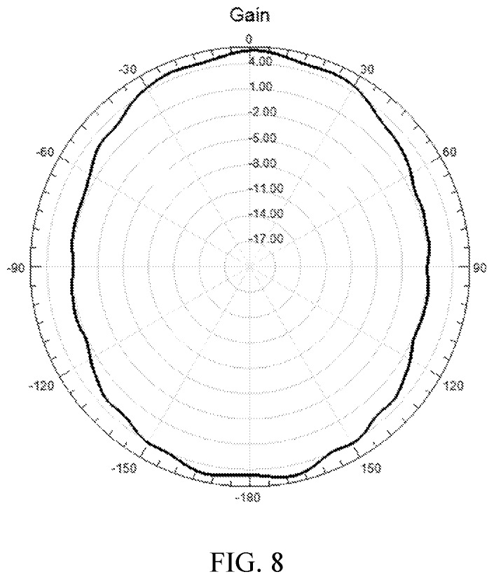

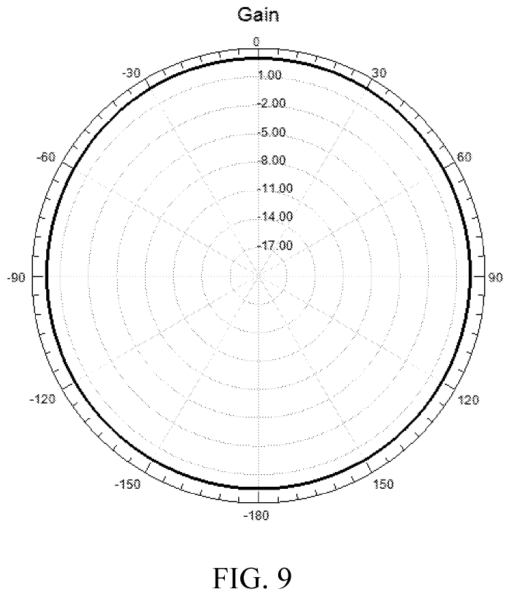

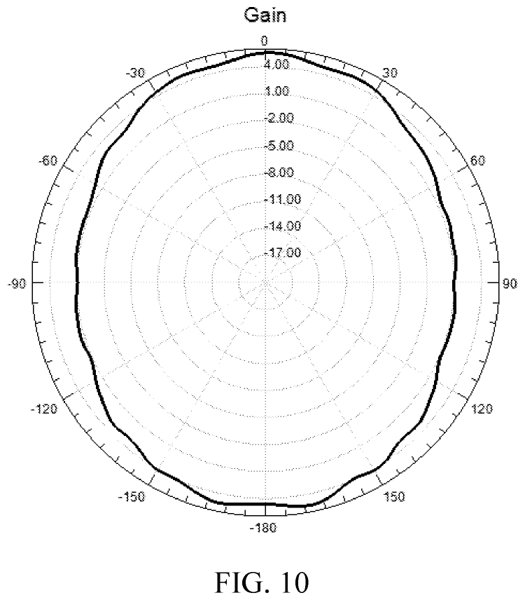

With reference to FIGS. 1-8, the present disclosure provides an external triple-frequency antenna for an unmanned aerial vehicle, comprising a substrate 1, vibrator circuits, and a feed line. Preferably, the vibrator circuits are laid on the front and back sides of the substrate 1 in the form of a plurality of microstrip lines. Specifically, the vibrator circuits comprise a high-frequency vibrator circuit, a middle-frequency vibrator circuit 3, and a low-frequency vibrator circuit 4; preferably, a shared microstrip line is disposed between the middle-frequency vibrator circuit 3 and the low-frequency vibrator circuit 4; in addition, the feed line comprises a first feed line 5 and a second feed line 6, wherein the first feed line 5 is connected to the high-frequency vibrator circuit; and the second feed line 6 is connected to the shared microstrip line, and a capacitor 9 is disposed at the connection of the second feed line 6 and the shared microstrip line. In this way, the external triple-frequency antenna for an unmanned aerial vehicle can be designed by using the end loading technology of capacitor 9, so that the external triple-frequency antenna for an unmanned aerial vehicle can achieve good performance, thus greatly reducing the influence of the feed line on the pattern, and achieving the fact that two feed points can meet the requirements of three frequency bands of 978 MHZ, 1.09 GHz, and 5.8 GHz at the same time.

Further, the high-frequency vibrator circuit in the present embodiment comprises a first high-frequency vibrator circuit 21 and a second high-frequency vibrator circuit 22 disposed at one end of the substrate 1; the first high-frequency vibrator circuit 21 and the second high-frequency vibrator circuit 22 are symmetrically disposed on the front and back sides of the substrate 1; preferably, the first high-frequency vibrator circuit 21 and the second high-frequency vibrator circuit 22 have the same line structure, and are both provided with two high-frequency vibrator circuit units, and the opening directions of the two high-frequency vibrator circuit units on the same side face are oppositely disposed.

Further preferably, both of the two high-frequency vibrator circuit units include a U-shaped microstrip line 211, and extended microstrip lines 212 extended at both ends of the U-shaped microstrip line 211. In the present embodiment, in order to adjust an antenna standing wave signal, it is preferable that the substrate 1 on one side of each of the extended microstrip lines 212 is provided with a notch 11.

More specifically, the shared microstrip line in the present embodiment comprises a first microstrip line 71 and a second microstrip line 72 disposed on the back side of the substrate 1 along the length direction of the substrate 1, and a third microstrip line 73 disposed on the front side of the substrate 1 along the width direction of the substrate 1. The first microstrip line 71, the second microstrip line 72, and the third microstrip line 73 designed in this way form a shared microstrip line of the middle-frequency vibrator circuit 3 and the low-frequency vibrator circuit 4.

In the present embodiment, since the middle and low resonance frequencies are relatively close to each other, the provision of the shared microstrip line described above not only enables the middle-frequency vibrator circuit 3 and the low-frequency vibrator circuit 4 to be coupled to each other, but also effectively saves space and increases their resonance strengths by using the element arms of each other.

Further, it is preferable that in this embodiment, two ends of the third microstrip line 73 extend to two sides along the length direction of substrate 1, respectively, with a fourth microstrip line 31, a fifth microstrip line 32, a sixth microstrip line 41, and a seventh microstrip line 42. The fourth microstrip line 31, the fifth microstrip line 32, and the shared microstrip line form a middle-frequency vibrator circuit 3. The sixth microstrip line 41, the seventh microstrip line 42, and the shared microstrip line form a low-frequency vibrator circuit 4.

Preferably, the middle-frequency vibrator circuit 3 and the low-frequency vibrator circuit 4 located on the front side of the substrate 1 are respectively disposed in a U-shape, and the opening directions of the middle-frequency vibrator circuit 3 and the low-frequency vibrator circuit 4 are disposed in opposite directions; in addition, in order to adjust the antenna standing wave signal, avoidance slots 12 are disposed on the substrate 1 at the end positions of the fourth microstrip line 31, fifth microstrip line 32, sixth microstrip line 41, and seventh microstrip line 42, so that the ends of the fourth microstrip line 31, fifth microstrip line 32, sixth microstrip line 41, and seventh microstrip line 42 are exposed, and then the antenna standing wave signal is adjusted.

Further, preferably, in the present embodiment, the first feed line 5 is disposed on the back side of the substrate 1. In particular, the first feed line 5 disposed on the back side of the substrate 1 is connected to the high-frequency vibrator circuit unit along the length direction of the middle part of the substrate 1. Preferably, the inner and outer conductors in the first feed line 5 in the present embodiment are electrically connected to two high-frequency vibrator circuit units on the back side of the substrate 1, respectively.

Further, the above-mentioned second feed line 6 in the present embodiment is disposed on the front side of the substrate 1. Specifically, the second feed line 6 disposed on the front side of the substrate 1 is connected to the above-mentioned shared microstrip line along the length direction of the middle part of the substrate 1. Further, in the present embodiment, the inner conductor in the second feed line 6 is electrically connected to the shared microstrip line via two capacitors 9 respectively, and then forms a feed point structure; in addition, the outer conductor is connected to a tenth microstrip line 83 disposed below the second feed line 6, and the tenth microstrip line 83 is connected to the shared microstrip line.

The above-mentioned tenth microstrip line 83 in the present embodiment functions is equivalent to the role of a ground line, and can reduce mutual interference when the first feed line 5 and the second feed line 6 perform transmission.

Further preferably, in the present embodiment, an eighth microstrip line 81 and a ninth microstrip line 82 are respectively disposed along the length direction on the front side and back side of the substrate 1. The eighth microstrip line 81 and the ninth microstrip line 82 are respectively connected to the high-frequency vibrator circuit unit adjacent to the middle-frequency vibrator circuit 3, and also function as a ground line as the above-mentioned tenth microstrip line 83, so as to reduce mutual interference when the first feed line 5 and the second feed line 6 perform transmission.

Further, in the present embodiment, an eleventh microstrip line 84 and a twelfth microstrip line 85 are respectively disposed in the middle parts of the front side and back side of the substrate 1 along the width direction of the substrate 1. The eleventh microstrip line 84 is connected to the above-mentioned ninth microstrip line 82, and the twelfth microstrip line 85 is connected to the above-mentioned tenth microstrip line 83, so that the length of the antenna standing wave signal can be adjusted by providing the eleventh microstrip line 84 and the twelfth microstrip line 85:

Where, alternatively or additionally, the high-frequency vibrator circuit comprises a first high-frequency vibrator circuit and a second high-frequency vibrator circuit; and the first high-frequency vibrator circuit and the second high-frequency vibrator circuit are symmetrically disposed on a front side and a back side of the substrate:

Where, alternatively or additionally, the first high-frequency vibrator circuit and the second high-frequency vibrator circuit are both provided with two high-frequency vibrator circuit units, and both of the high-frequency vibrator circuit units comprise a U-shaped microstrip line and an extended microstrip line extending at two ends of the U-shaped microstrip line:

Where, alternatively or additionally, the substrate on one side of the extended microstrip line is provided with a notch:

Where, alternatively or additionally, the shared microstrip line comprises a first microstrip line and a second microstrip line disposed on the back side of the substrate along a length direction of the substrate, and a third microstrip line disposed on the front side of the substrate along a width direction of the substrate, wherein the third microstrip line is connected to the second feed line:

Where, alternatively or additionally, two ends of the third microstrip line extend to two sides along the length direction of the substrate, respectively, with a fourth microstrip line, a fifth microstrip line, a sixth microstrip line, and a seventh microstrip line:

Where, alternatively or additionally, the fourth microstrip line, the fifth microstrip line, and the shared microstrip line form the middle-frequency vibrator circuit; and the sixth microstrip line, the seventh microstrip line, and the shared microstrip line form the low-frequency vibrator circuit:

Where, alternatively or additionally, an eighth microstrip line and a ninth microstrip line are respectively disposed along the length direction on the front side and back side of the substrate, and the eighth microstrip line and the ninth microstrip line are respectively connected to the high-frequency vibrator circuit unit:

Where, alternatively or additionally, the substrate is provided with a tenth microstrip line connected to the third microstrip line along the length direction:

Where, alternatively or additionally, an eleventh microstrip line and a twelfth microstrip line are respectively disposed along the width direction of the substrate in the middle parts of the front side and back side of the substrate, the eleventh microstrip line being connected to the ninth microstrip line, and the twelfth microstrip line being connected to the tenth microstrip line.

It is an object of the present disclosure to provide an external triple-frequency antenna for an unmanned aerial vehicle. The line layout of the external triple-frequency antenna for an unmanned aerial vehicle is compact and has a good gain effect, and can effectively meet the use requirements of high frequency band, middle frequency band, and low frequency band.

Advantageous effects of the present disclosure include that the present disclosure discloses an external triple-frequency antenna for an unmanned aerial vehicle, comprising a substrate, vibrator circuits, and a feed line. Preferably, the vibrator circuits are laid on the substrate. The vibrator circuits comprise a high-frequency vibrator circuit, a middle-frequency vibrator circuit, and a low-frequency vibrator circuit; a shared microstrip line is disposed between the middle-frequency vibrator circuit and the low-frequency vibrator circuit; the feed line comprises a first feed line and a second feed line, wherein the first feed line is connected to the high-frequency vibrator circuit; and the second feed line is connected to the shared microstrip line, and a capacitor is disposed at the connection of the second feed line and the shared microstrip line. The external triple-frequency antenna for an unmanned aerial vehicle designed in such a structure is compact in the line layout, has a good gain effect, and can effectively meet the use requirements of high frequency band, middle frequency band, and low frequency band. It is noted that the foregoing describes only a preferred embodiment of the present disclosure and the technical principles applied thereto. It will be understood by those skilled in the art that the present disclosure is not limited to the specific embodiments herein, and that various obvious changes, rearrangements, and substitutions can be made by those skilled in the art without departing from the scope of the present disclosure. Therefore, while the disclosure has been described in considerable details with reference to the above embodiments, it is to be understood that the disclosure is not limited to the above embodiments, but it is intended to cover various other equivalent embodiments without departing from the concept or scope of the present disclosure.

What is claimed is:

1. An external triple-frequency antenna for an unmanned aerial vehicle, comprising:
a substrate;
vibrator circuits laid on the substrate, wherein the vibrator circuits comprise a high-frequency vibrator circuit, a middle-frequency vibrator circuit, and a low-frequency vibrator circuit; and a shared microstrip line is disposed between the middle-frequency vibrator circuit and the low-frequency vibrator circuit; and
a feed line, comprising a first feed line and a second feed line, wherein the first feed line is connected to the high-frequency vibrator circuit; and the second feed line is connected to the shared microstrip line, and a capacitor is disposed at a connection of the second feed line and the shared microstrip line.

2. The external triple-frequency antenna for the unmanned aerial vehicle according to claim 1, wherein the high-frequency vibrator circuit comprises a first high-frequency vibrator circuit and a second high-frequency vibrator circuit; and the first high-frequency vibrator circuit and the second high-frequency vibrator circuit are symmetrically disposed on a front side and a back side of the substrate.

3. The external triple-frequency antenna for the unmanned aerial vehicle according to claim 2, wherein the first high-frequency vibrator circuit and the second high-frequency vibrator circuit are both provided with two high-frequency vibrator circuit units, and both of the high-frequency vibrator circuit units comprise a U-shaped microstrip line and an extended microstrip line extending at two ends of the U-shaped microstrip line.

4. The external triple-frequency antenna for the unmanned aerial vehicle according to claim 3, wherein the substrate on one side of the extended microstrip line is provided with a notch.

5. The external triple-frequency antenna for the unmanned aerial vehicle according to claim 3, wherein the shared microstrip line comprises a first microstrip line and a second microstrip line disposed on a back side of the substrate along a length direction of the substrate, and a third microstrip line disposed on a front side of the substrate along a width direction of the substrate, and wherein the third microstrip line is connected to the second feed line.

6. The external triple-frequency antenna for the unmanned aerial vehicle according to claim 5, wherein two ends of the third microstrip line extend to two sides along the length direction of the substrate, respectively, with a fourth microstrip line, a fifth microstrip line, a sixth microstrip line, and a seventh microstrip line.

7. The external triple-frequency antenna for the unmanned aerial vehicle according to claim 6, wherein the fourth microstrip line, the fifth microstrip line, and the shared microstrip line form the middle-frequency vibrator circuit; and the sixth microstrip line, the seventh microstrip line, and the shared microstrip line form the low-frequency vibrator circuit.

8. The external triple-frequency antenna for the unmanned aerial vehicle according to claim 5, wherein an eighth microstrip line and a ninth microstrip line are respectively disposed along the length direction on the front side and the back side of the substrate, and the eighth microstrip line and the ninth microstrip line are respectively connected to the high-frequency vibrator circuit unit.

9. The external triple-frequency antenna for the unmanned aerial vehicle according to claim 8, wherein the substrate is provided with a tenth microstrip line connected to the third microstrip line along the length direction.

10. The external triple-frequency antenna for the unmanned aerial vehicle according to claim 9, wherein an eleventh microstrip line and a twelfth microstrip line are respectively disposed along the width direction of the substrate in middle parts of the front side and the back side of the substrate, the eleventh microstrip line being connected to the ninth microstrip line, and the twelfth microstrip line being connected to the tenth microstrip line.
